(19) United States
(12) Patent Application Publication
(10) Pub. No.: US 2005/0123201 A1
(43) Pub. Date: Jun. 9, 2005

(54) Image processing apparatus for detecting and recognizing mobile object

(75) Inventors: Hiroyuki Nakashima, Yokohama (JP); Hiroaki Natori, Kawasaki (JP); Kunihiro Ikeda, Kawasaki (JP); Shinji Hidaka, Kawasaki (JP); Nobumasa Sasaki, Kawasaki (JP); Tamotsu Amamoto, Yokohama (JP); Masashi Murakumo, Yokohama (JP); Hajime Kanno, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/829,248

(22) Filed: Apr. 22, 2004

(30) Foreign Application Priority Data
Dec. 9, 2003 (JP) 2003-410234

(51) Int. Cl. G06K 9/46; G06K 9/00; G06K 9/66

(52) U.S. Cl. 382/195; 382/103; 382/104

(57) ABSTRACT

A part of a high-resolution image captured by a camera is extracted as a partial image, a low-resolution image is generated using the extracted partial image, and a mobile object is detected using a low-resolution image. Then, using a high-resolution image, a recognition process for the detected mobile object is performed.

### BACKGROUND OF THE INVENTION

1. Field of the Invention

The present invention relates to an image processing apparatus for detecting and recognizing a mobile object such as a vehicle traveling on a common road, from an image obtained using a camera.

2. Description of the Related Art

A common camera has its resolution for capture and display of an image of normal image quality of television. On a common road, one camera of the above-mentioned normal resolution can detect and capture a vehicle, but there is the problem of image quality (resolution), and the image processing such as extracting data from an image, recognizing a character pattern, etc. cannot be successfully performed.

To solve the above-mentioned problem, a high-resolution camera having the resolution higher than the image quality of television can be used to obtain an image to be acceptably used in the above-mentioned image processing. In this case, based on the feature of the hardware for use in detection, a vehicle is detected using the entire captured image. In this method, since a larger number of pixels are used than in the method in which a camera of normal resolution is used, the load of the hardware in detecting a vehicle becomes heavier. Therefore, it is necessary to provide a higher-performance image processing apparatus to be mounted on the side of a road, etc. and take countermeasures against the heat generated by a heavy load.

In this situation, a method of detecting and recognizing a vehicle using two cameras, that is, a first camera of normal resolution and a second camera of high resolution, has been proposed (for example, refer to Patent Literature 1). In this method, the first camera captures an image in a wide range, and the position and the movements of a vehicle are predicted. Then, the second camera capturing a detailed image is controlled according to the information from the first camera, and the number of the vehicle, etc. is captured.

Patent Literature 1: Japan Patent Application Laid-open No. 08-050696

However, there are the following problems with the above-mentioned conventional vehicle detecting and recognizing method.

(1) Method of Using a Camera of Normal Resolution

Sufficient resolution cannot be obtained, and the subsequent image processing cannot be performed.

(2) Method of Using a High-Resolution Camera

It is necessary to prepare hardware of high performance for a high-resolution image.

It is necessary to take countermeasures against the heat generated by a heavy load.

(3) Method of Using two Cameras, that is, One Normal-Resolution Camera and One High-Resolution Camera

Two sets of devices are required. Each set includes a cameras and an LED (light emitting diode) device for capturing an image at nighttime.

The movements are predicted from the image, but there can be a case in which no images are obtained depending on the prediction precision.

Since the direction and the zooming of a camera are to be adjusted after a movement prediction, a time lag occurs.

The precision in processing and mounting a camera turning device is required.

### SUMMARY OF THE INVENTION

The present invention aims at providing an image processing apparatus for detecting a vehicle from an image captured by a high-resolution camera and recognizing the vehicle using a high-resolution image without increasing a hardware load in performing a detecting and recognizing process on a vehicle on a common road.

The image processing apparatus according to the present invention includes an extraction device, a detection device, and a recognition device, and identifies a mobile object contained in an image captured by a high-resolution camera.

The extraction device extracts a part of a high-resolution image captured by the high-resolution camera as a partial image, and generates a low-resolution image having the resolution lower than the captured image using the extracted partial image. The detection device detects a mobile object using the low-resolution image. The recognition device recognizes a mobile object using a high-resolution image transmitted from the high-resolution camera when the mobile object is detected, thereby outputting a recognition result.

### BRIEF DESCRIPTION OF THE DRAWINGS

FIG. 1 shows the principle of the image processing apparatus according to the present invention;

FIG. 2 shows the configuration of the image processing system;

FIG. 3 shows the first extracting method for a detection image;

FIG. 4 shows the second extracting method for a detection image;

FIG. 5 shows the third extracting method for a detection image;

FIG. 6 shows the fourth extracting method for a detection image;

FIG. 7 shows positions of a detection window;

FIG. 8 shows angles of a detection window;

FIG. 9 shows the first extracting method for a recognition image;

FIG. 10 shows the second extracting method for a recognition image;

FIG. 11 shows the third extracting method for a recognition image;

FIG. 12 shows a sequence from detection to recognition of an image;

FIG. 13 is a flowchart of the vehicle detecting and recognizing process;

FIG. 14 is a flowchart of the window selecting process;

FIG. 15 shows the first extracted portion;

FIG. 16 shows the second extracted portion;

FIG. 17 shows the reconfiguration of an image; and

FIG. 18 shows recording media.

### DETAILED DESCRIPTION OF THE PREFERRED EMBODIMENTS

The best modes for carrying out the present invention are described below in detail by referring to the attached drawings.

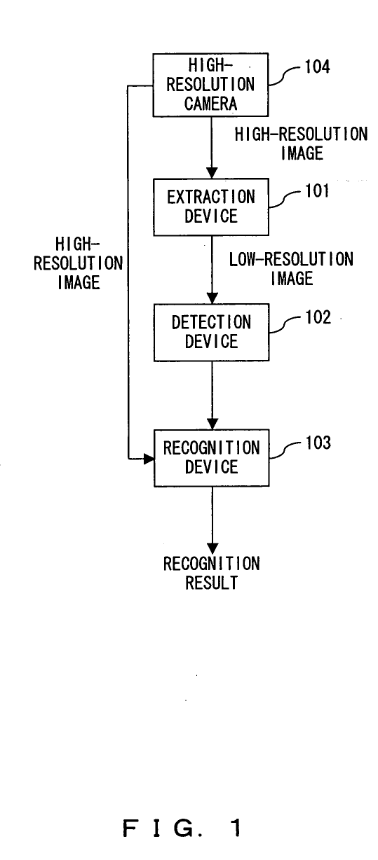

FIG. 1 shows the principle of the image processing apparatus according to the present invention. The image processing apparatus shown in FIG. 1 comprises an extraction device 101, a detection device 102, and a recognition device 103, and identifies a mobile object contained in the image captured by a high-resolution camera 104.

The extraction device 101 extracts a part of the high-resolution image captured by the high-resolution camera 104 as a partial image, and generates a low-resolution image having a resolution lower than the extracted partial image. The detection device 102 detects a mobile object using the low-resolution image. When the mobile object is detected, the recognition device 103 recognizes the mobile object using a high-resolution image transmitted from the high-resolution camera 104, and outputs a recognition result.

First, the extraction device 101 generates a low-resolution image for detection using one or more partial images extracted from a high-resolution image, and transfers them to the detection device 102. Then, the detection device 102 performs a detecting process using the low-resolution image, and transmits a notification that a mobile object has been detected to the recognition device 103. Then, the recognition device 103 performs a recognizing process using a high-resolution image transmitted when the notification is received.

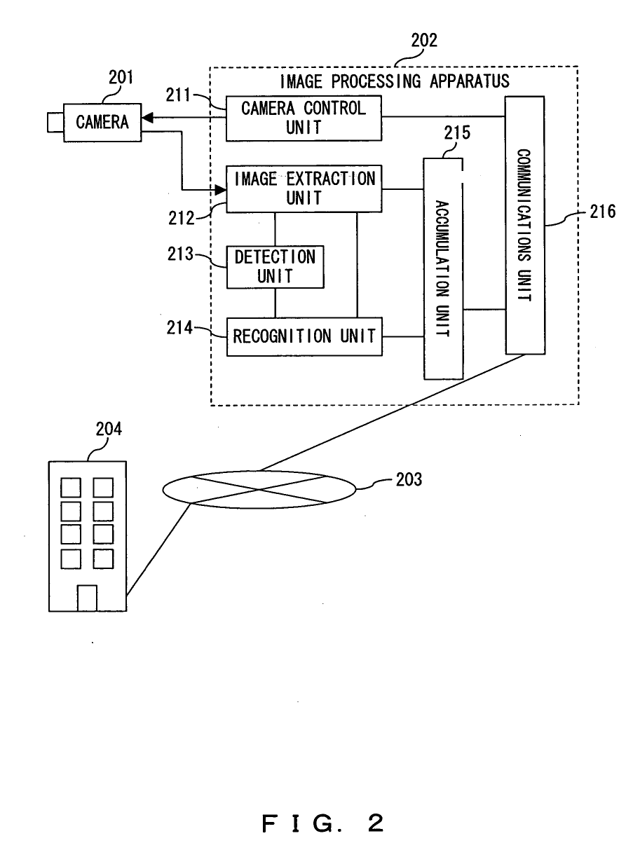

The extraction device 101, the detection device 102, and the recognition device 103 respectively correspond to, for example, an image extraction unit 212, a detection unit 213, and a recognition unit 214 shown in FIG. 2 and described later.

According to the present invention, in the detecting and recognizing process on the mobile object such as a vehicle, etc. on a common road, a detecting process is performed on a low-resolution image generated using a part of a high-resolution image. Therefore, a mobile object can be detected from an image captured by a high-resolution camera and recognized from a high-resolution image without increasing the load of hardware.

More specifically, the following effects can be obtained.
Sufficient resolution for image processing can be obtained.
Without high-performance hardware, a mobile object can be detected from an image captured by a high-resolution camera.
Since the load of hardware can be reduced, the countermeasures against the heat can be attenuated.
Only one set of devices including a camera and a LED device for capturing an image at nighttime is to be prepared, but the set is of high resolution type.
Since all processes are performed using an image from one camera, it is not necessary to predict movements.
Since all processes are performed using an image from one camera, it is not necessary to adjust the direction or zooming of a camera and no time lag occurs.
It is not always necessary to prepare a camera turning device.

In the present embodiment, the process of detecting a vehicle by extracting a part of an image from an image captured by a high-resolution camera is separate from the process of image processing such as vehicle recognition. Using an image extracted with the resolution of image quality of television from an image captured by a high-resolution camera, a vehicle can be detected without a heavy load of hardware. When a vehicle is detected, an image of a high-resolution camera is transmitted to an image processing phase for use in extracting data, recognizing a character pattern, etc.

FIG. 2 shows the configuration of the image processing system according to an embodiment of the present invention. The image processing system shown in FIG. 2 comprises a camera 201 and an image processing apparatus 202. The image processing apparatus 202 is connected to a center 204 through a communications network 203. The image processing apparatus 202 comprises a camera control unit 211, an image extraction unit 212, a detection unit 213, a recognition unit 214, an accumulation unit 215, and a communications unit 216.

The camera 201 is a high-resolution camera with a turntable, and can capture an image of an entire road width. The camera control unit 211 adjusts the focus, the capturing direction, etc. according to a control command from the center 204. The image extraction unit 212 extracts an image of a normal television image size from an input image of high resolution from the camera 201, and stores the extracted image in the accumulation unit 215.

The detection unit 213 detects a vehicle using the extracted image. The recognition unit 214 recognizes an object such as the number plate, etc. of the detected vehicle, and stores the process result such as the recognition data, etc. in the accumulation unit 215. The communications unit 216 receives a control command from the center 204, transfers it to the camera control unit 211, and transmits the data stored in the accumulation unit 215 to the center 204.

The image extraction unit 212, the detection unit 213, and the recognition unit 214 can be realized by the same hardware, or can be realized by the respective hardware. The image extraction unit 212, or the image extraction unit 212 and the detection unit 213 can be provided in the camera 201.

As hardware, an information processing device comprising, for example, a CPU (central process unit), ROM (read only memory), RAM (random access memory), and input/output ports is used. The ROM stores a program and data for use in a process. The RAM stores image data, etc. in the process. The CPU performs a process required to detect and recognize a vehicle by executing a program using the RAM. Instead of the CPU, a DSP (digital signal processor) for high-speed image processing can also be used.

The camera 201 constantly captures and shows the lanes at a predetermined angle of view. The image extraction unit 212 extracts from an image transmitted from the camera 201 a partial image using a window for detection of a vehicle. A detection image is generated from one or more partial images extracted as described above.

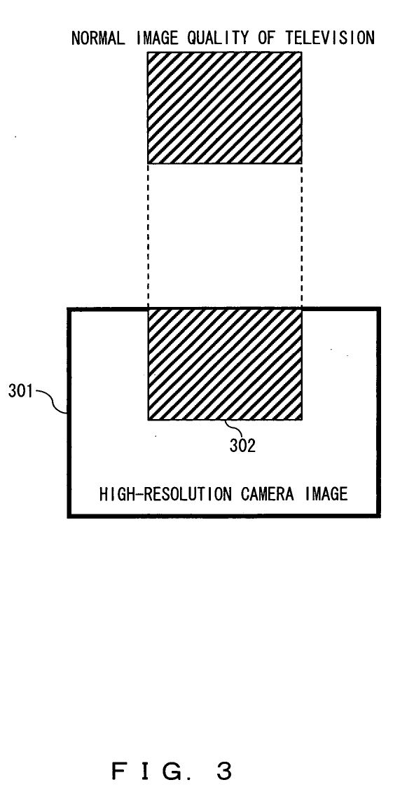

FIGS. 3 through 6 show the method of extracting a detection image using detection windows of various shapes. A high-resolution camera image 301 is transmitted from the camera 201, and comprises 1320*1080 (about 1.45 million) pixels in this case. By changing the shape of the detection window, the following features and effects can be obtained.

FIG. 3 shows a standard extracting method for a detection image. A detection window 302 shown in FIG. 3 is provided at the upper center of the high-resolution camera image 301, and comprises 640*525 (about 380 thousand) pixels corresponding to normal image quality of television. Therefore, the image extracted by the detection window 302 can be input as is as a detection image. This extracting method is effective when a specific area of an image is to be checked as in the case in which the lane is vertically shown at the center of the high-resolution camera image 301.

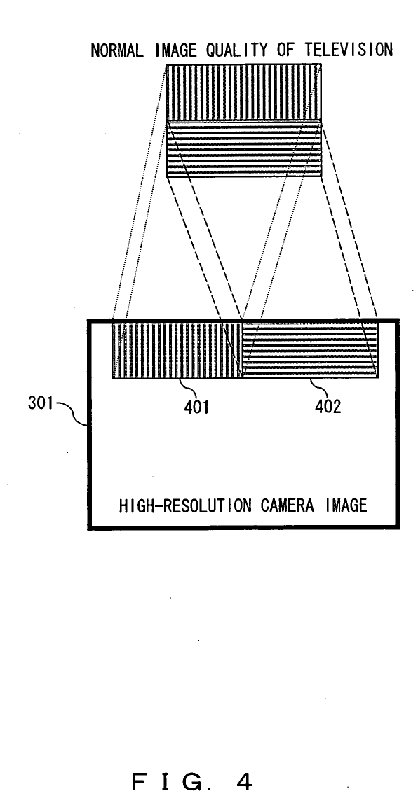

FIG. 4 shows the extracting method in which two thin and long detection windows are horizontally arranged. Detection windows 401 and 402 are provided at the upper left and right portions of the high-resolution camera image 301, and each of them comprises 640*262 (about 190 thousand) pixels. When two images extracted using these detection windows are input as a detection image, two images are vertically arranged and an image of 640*525 pixels corresponding to normal image quality of television can be generated. The extracting method is effective for vertical travel of some extent of width as in the case in which two lanes in the same traveling direction are shown in the high-resolution camera image 301.

In the example shown in FIG. 4, two detection windows are horizontally arranged. Generally, however, three or more detection windows can be horizontally arranged in extracting images. In this case, a plurality of extracted images are vertically arranged to generate an image corresponding to normal image quality of television. Furthermore, instead of the upper end of the high-resolution camera image 301, the detection windows can also be horizontally arranged at the lower end portion.

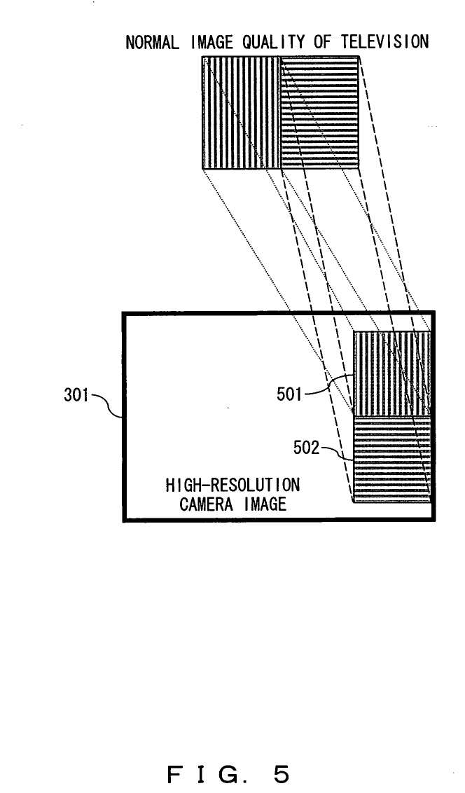

FIG. 5 shows the extracting method in which two thin and long detection windows are vertically arranged. Detection windows 501 and 502 shown in FIG. 5 are provided at the upper and lower right portions of the high-resolution camera image 301. Each of the detection windows comprises 320*512 (about 190 thousand) pixels. When two images extracted by the detection windows are input as detection images, two images are horizontally arranged to generate a 640*525 pixel image corresponding to normal image quality of television. This extracting method is effective in horizontal movement of some extent of height as in the case in which two lanes in the same traveling direction are horizontally shown in the high-resolution camera image 301.

In the example shown in FIG. 5, two detection windows are vertically arranged. Generally, three or more detection windows can be vertically arranged to extract images. In this case, a plurality of extracted images are horizontally arranged to generate an image corresponding to normal image quality of television.

In the three above-mentioned extracting methods, a detection image is generated from the high-resolution camera image 301 at each time, and a video picture for detection of a vehicle is generated by arranging a plurality of detection images in a time series.

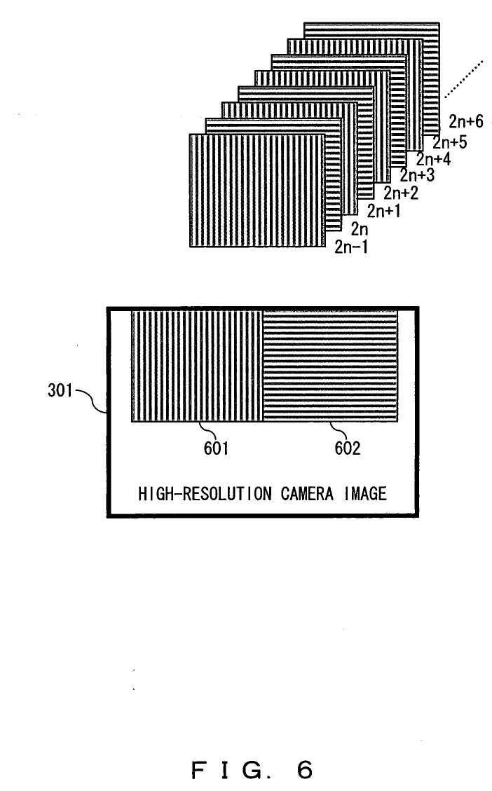

FIG. 6 shows a extracting method in which two detection windows of the same shape as shown in FIG. 3 are horizontally arranged. Detection windows 601 and 602 shown in FIG. 6 are provided at the upper right and left of the high-resolution camera image 301, and each of the window comprises 640*525 (about 380 thousand) pixels.

When the two images extracted by these detection windows are input as detection images, the two images are inserted alternately into an odd frame and an even frame of the NTSC (National Television Standards Committee), thereby generating a 640*525 video picture corresponding to normal image quality of television. For example, the image extracted by the detection window 601 is inserted into an odd frame, and the image extracted by the detection window 602 is inserted into an even frame. This extracting method is based on the feature of the NTSC signal, and is effective for vertical travel of some extent of width as in the case shown in FIG. 4.

As described above, a part of the high-resolution camera image 301 is extracted to generate a detection image of normal image quality of television with a smaller number of pixels, thereby successfully detecting a vehicle using hardware of the processing ability of normal image quality of television.

Described below is the method of determining the position, size, and angle of a detection window.

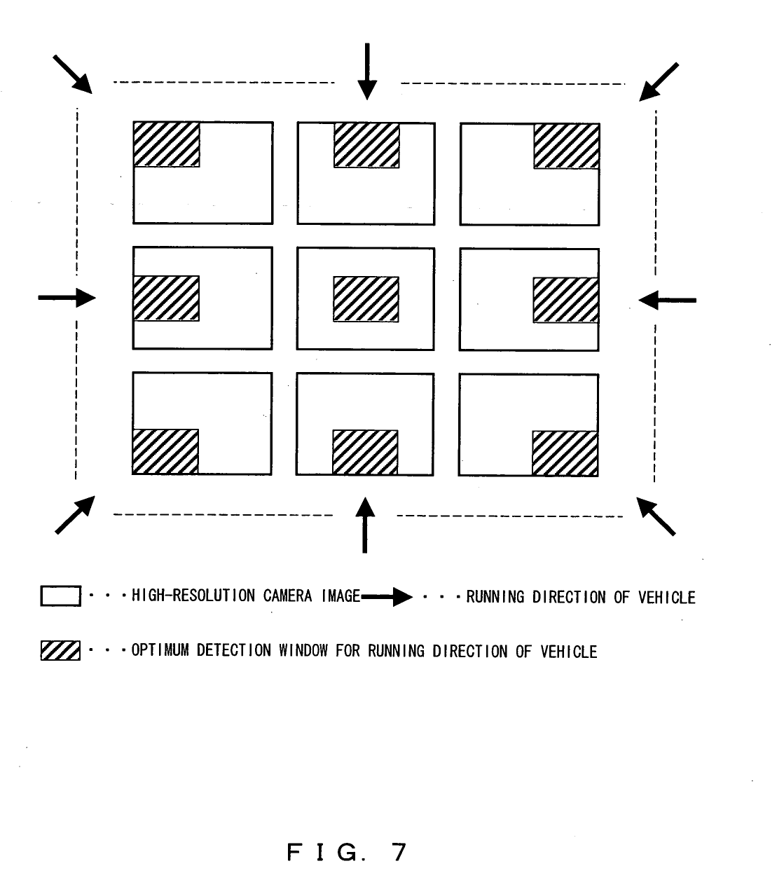

FIG. 7 shows the relationship between the running direction of a vehicle and the position of the detection window when there is the possibility that the vehicle enters the screen at various angles. In FIG. 7, the boldface rectangle indicates a capturing area of an image of a high-resolution camera, and the boldface arrow indicates the running direction of a vehicle into the capturing area. In this example, the position closest to the running direction of a vehicle into the capturing area is selected as the optimum position. By thus changing the position of the detection window, the priority in the running direction can be set in the vehicle detection algorithm.

The size of a detection window depends on the specifications of the hardware when an image is extracted. Specifically, for example, the size of the detection window is changed depending on the format of a video signal for detection such as an NTSC signal, a PAL (phase alternation by line) signal, an analog signal, a digital signal, a VGA (video graphics array) signal, an SVGA (super video graphics array) signal, etc.

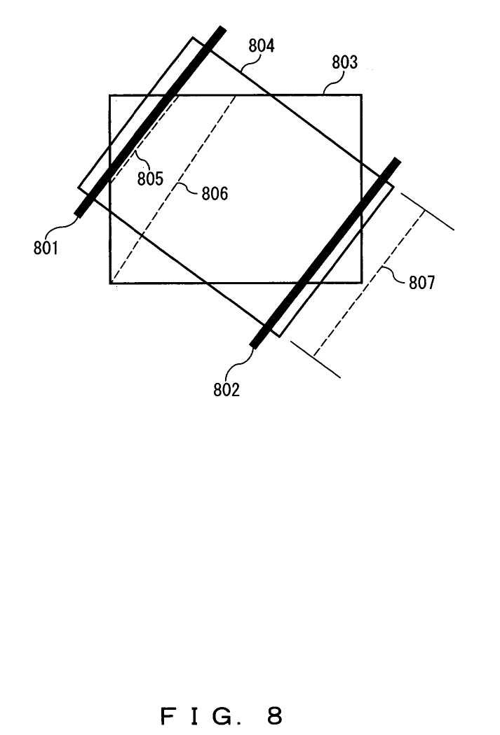

Furthermore, it is also possible to change the angle of a detection window depending on the traveling direction of a vehicle. FIG. 8 shows an example of applying two types of window angles relative to the lane. When a detection window 803 is applied to the lane indicated by straight lines 801 and 802, the lengths of the broken lines 805 and 806 in the lane direction contained in the window are different. Therefore, there arises a difference in time in which the vehicle appears on the screen. On the other hand, when a detection window 804 is applied, the traveling distance of the vehicle on the screen is represented by the length of a broken line 807. Therefore, the time in which the vehicle appears on the screen can be kept constant. As a result, a constant vehicle detecting process can be performed.

The detection unit 213 detects a vehicle in a detection image extracted in the optimum detection window, and outputs a detection signal when a vehicle is detected in the image, thereby notifying the recognition unit 214 of the detection of a vehicle.

The basic algorithm of detecting a vehicle using edges contained in the image of a vehicle is described as follows.
1. Edges are extracted from a detection image (background image) not containing a vehicle.
2. Edges are extracted from a detection image input during the operation.
3. The edges of the background image is compared with the edges of the input image, and the edge image of the difference (vehicle only) is generated.
4. The pixel values of the edge image are projected on the coordinate axis in the traveling direction to generate a histogram.
5. It is determined from the shape of the distribution of the histogram whether or not a vehicle is contained in the input image.

Upon receipt of the detection signal from the detection unit 213, the recognition unit 214 captures an image, and then extracts data, recognizes a character pattern, recognizes the front view of the vehicle and the image of the driver, etc. using the captured image, thereby performing image processing. For example, when the character pattern of the number plate and the front view of the vehicle and the image of the driver are recognized, the image processing such as pattern matching, etc. is performed.

Normally, a high-resolution image from the camera 201 are captured as is, but depending on the shape, position, size, and angle of a detection window, it is determined where the vehicle is traveling in the image, and the capturing area of the image can be designated. When the capturing area is designated, a recognition image can be extracted using a recognition window.

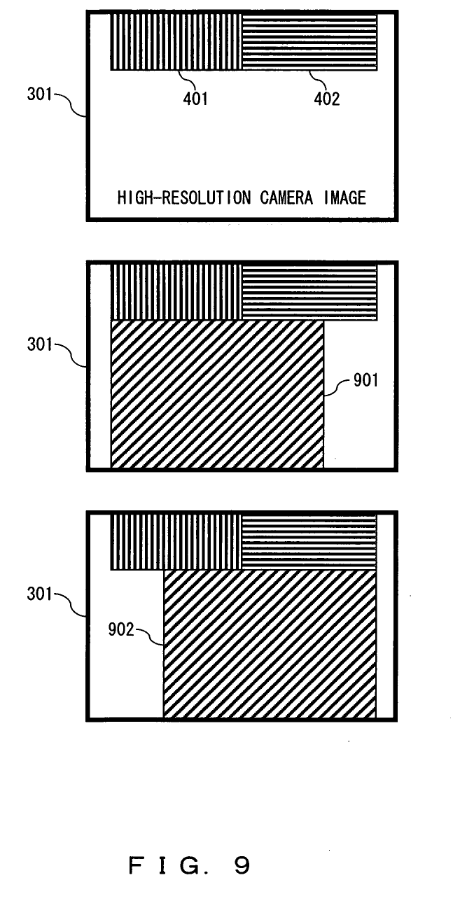

FIGS. 9 through 11 show the method of extracting a recognition image using recognition windows in various positions.

FIG. 9 shows the method of extracting a recognition image when the detection windows 401 and 402 shown in FIG. 4 are used. In this case, if the vehicle enters from the top of the screen and a vehicle is detected in the image extracted by the detection window 401, then a recognition image is extracted by a recognition window 901 from the high-resolution camera image 301. If a vehicle is detected in the image extracted by the detection window 402, then a recognition window 902 is used.

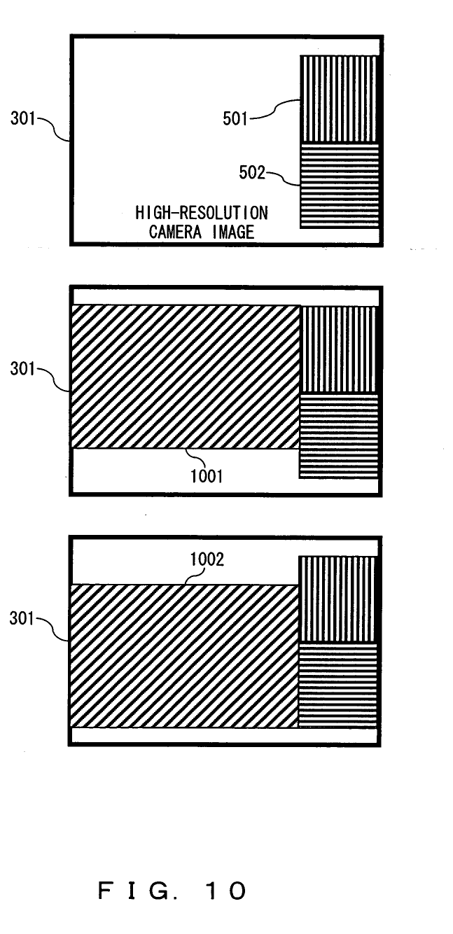

FIG. 10 shows the method of extracting a recognition image when the detection windows 501 and 502 shown in FIG. 5 are used. In this case, if the vehicle enters from the right side on the screen, and a vehicle is detected in the image extracted by the detection window 501, then a recognition image is extracted by a recognition window 1001. If a vehicle is detected in the image extracted by the detection window 502, then a recognition window 1002 is used.

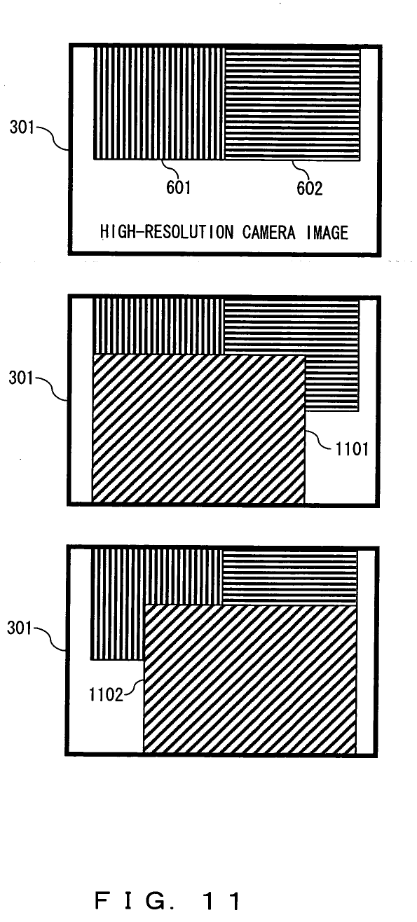

FIG. 11 shows the method of extracting a recognition image when the detection windows 601 and 602 shown in FIG. 6. In this case, if a vehicle enters from the top on the screen, and a vehicle is detected in the image extracted by the detection window 601, then a recognition image is extracted from a recognition window 1101. If a vehicle is detected in the image extracted by the detection window 602, then a recognition window 1102 is used.

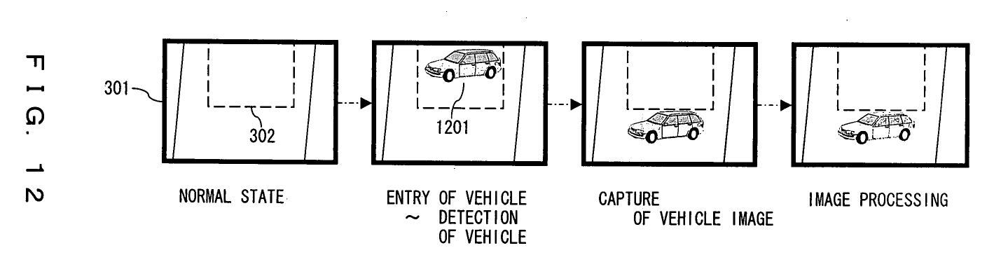

FIG. 12 shows a sequence of processes from the detection to the recognition of a vehicle. In this example, the detection window 302 shown in FIG. 3 is used. First, in a normal state in which no vehicle enters, the high-resolution camera image 301 from the camera 201 is input to the image extraction unit 212 and the recognition unit 214, and the image extracted by the detection window 302 is input to the detection unit 213. When a vehicle 1201 is detected in the detection image, a detection signal is output from the detection unit 213 to the recognition unit 214, and the recognition unit 214 captures an image of the vehicle 1201. Then, the recognition unit 214 performs image processing on the captured image, and the process result is stored in the accumulation unit 215.

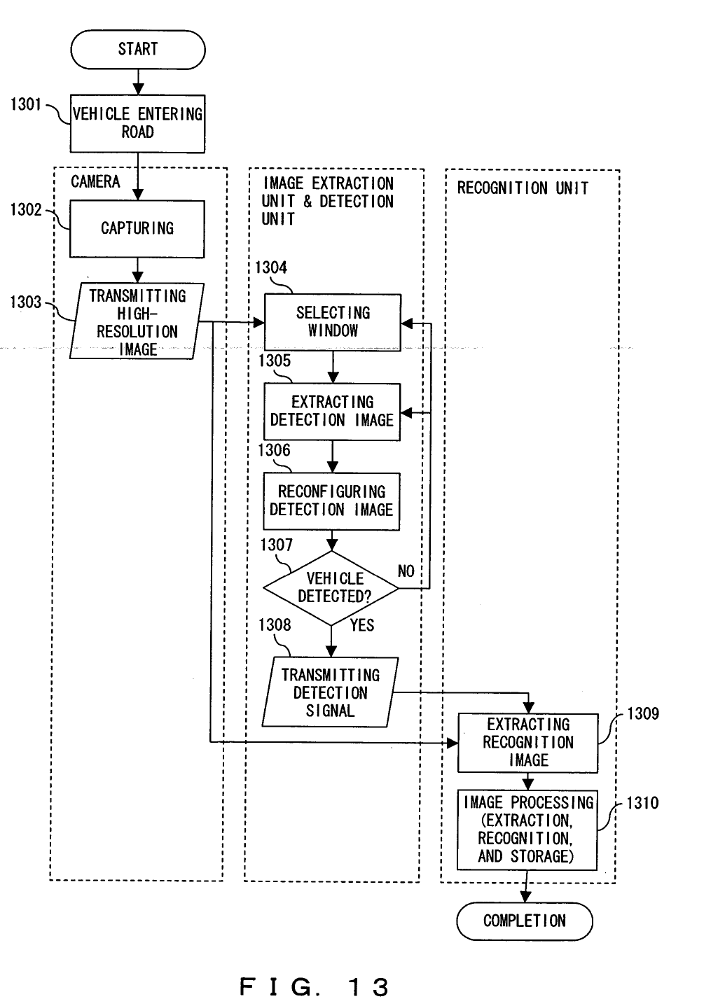

FIG. 13 is a flowchart of the vehicle detecting and recognizing process. The process is started after setting the camera 201 and adjusting an angle of view, etc. When a vehicle enters the road being captured (step 1301), the camera 201 obtains the high-resolution image (step 1302), and transmits it to the image extraction unit 212 (step 1303). At this time, a high-resolution image is also transferred to the recognition unit 214 through the image extraction unit 212.

Then, the image extraction unit 212 selects a prescribed detection window and recognition window (step 1304), extracts a detection image from a high-resolution image using a selected detection window, and stores it in the RAM (step 1305).

A window selecting method can be a method of manually setting a window in advance or a method of the image extraction unit 212 automatically selecting a window.

In the former case, when the camera 201 is mounted, the operator confirms the running direction of a vehicle using an image, and determines the shape, position, size, and angle of the detection window based on the running direction, etc. Simultaneously, a recognition window to be combined with the detection window is determined. The information about the determined detection window and the information about the determined recognition window are associated with each other, and stored in the storage device such as the ROM, etc. in the image extraction unit 212. Therefore, the image extraction unit 212 selects the predetermined detection window and recognition window.

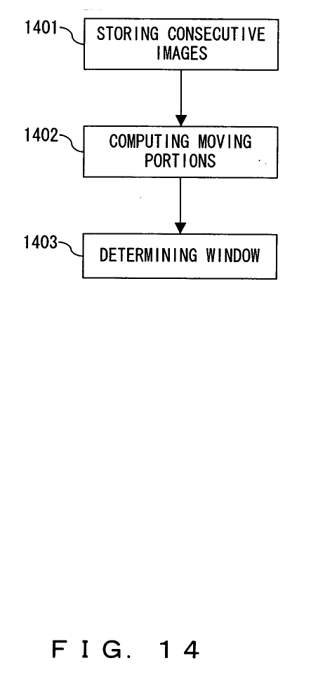

On the other hand, in the latter case, the information about various detection windows and the information about a recognition window associated with each detection window are stored in the storage device in the image extraction unit 212 in advance, and the optimum window is selected in the window selecting process as shown in FIG. 14.

The image extraction unit 212 stores consecutive high-resolution images in the RAM (step 1401), and a portion showing a difference (movement) from the background image and the traveling direction are computed by integrating or differentiating the stored images (step 1402). Then, based on the computation result, the shape, position, size, and angle of the detection window are determined, and the recognition window associated with the detection window is selected (step 1403).

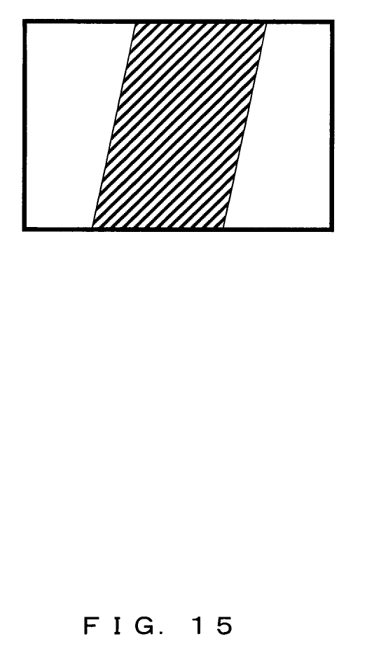

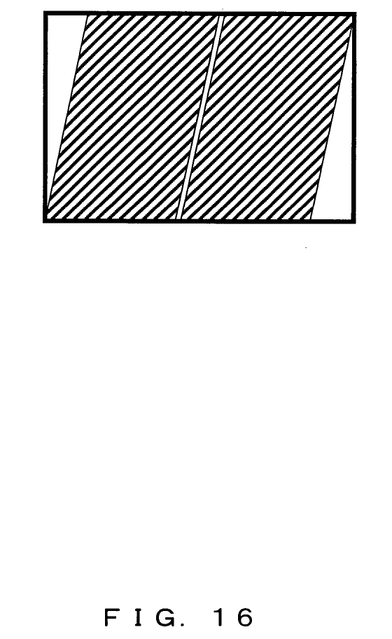

For example, when the diagonally shaded area shown in FIG. 15 is extracted as a portion of movement, the detection window 302 shown in FIG. 3 is selected. When the diagonally shaded area shown in FIG. 16 is extracted, the detection windows 401 and 402 or the detection windows 601 and 602 shown in FIG. 6 are selected.

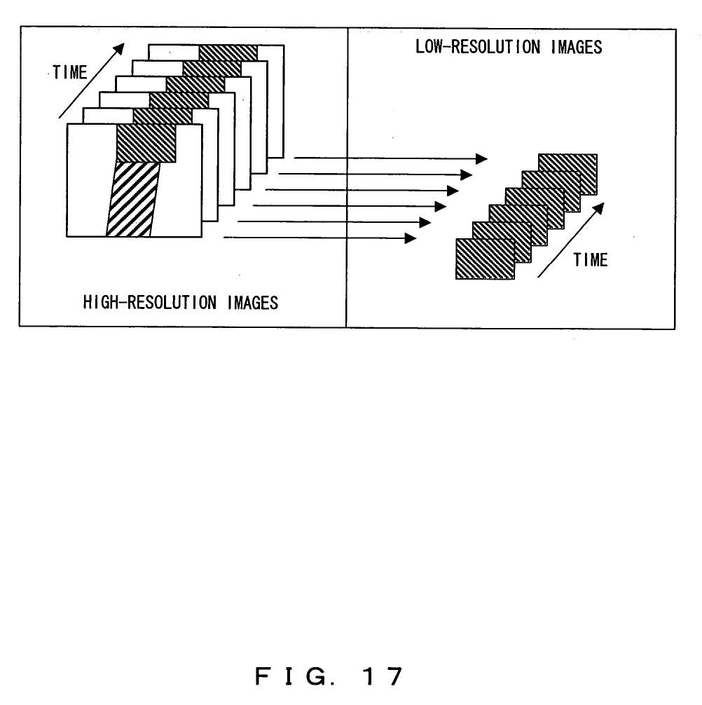

The image extraction unit 212 converts the extracted image stored in the RAM into the image format which can be processed by the detection unit 213, and reconfigures the detection image (step 1306). Thus, as shown in FIG. 17, the images extracted from the high-resolution images at respective times are arranged in a time series, thereby generating a video picture comprising detection images of low resolution.

Then, the detection unit 213 detects a vehicle using the reconfigured detection images (step 1307). If no vehicle is detected, the process in and after step 1305 are repeated. If a window is automatically selected, and if the state in which no vehicle is detected in the selected detection window continues for a predetermined time, then the processes in and after step 1304 are performed again. If a vehicle is detected in step 1307, the detection unit 213 transmits a detection signal to the recognition unit 214 (step 1308).

When a recognition image is extracted as shown in FIGS. 9 through 11, the detection unit 213 identifies the recognition window corresponding to a detection window in which a vehicle is detected, and transmits the identification information of the recognition window together with a detection signal.

Then, the recognition unit 214 is triggered by the reception of the detection signal to extract a recognition image from a high-resolution image using the recognition window having the received identification information (step 1309). Then, it performs the image processing on the recognition image, and stores the process result in the accumulation unit 215 (step 1310).

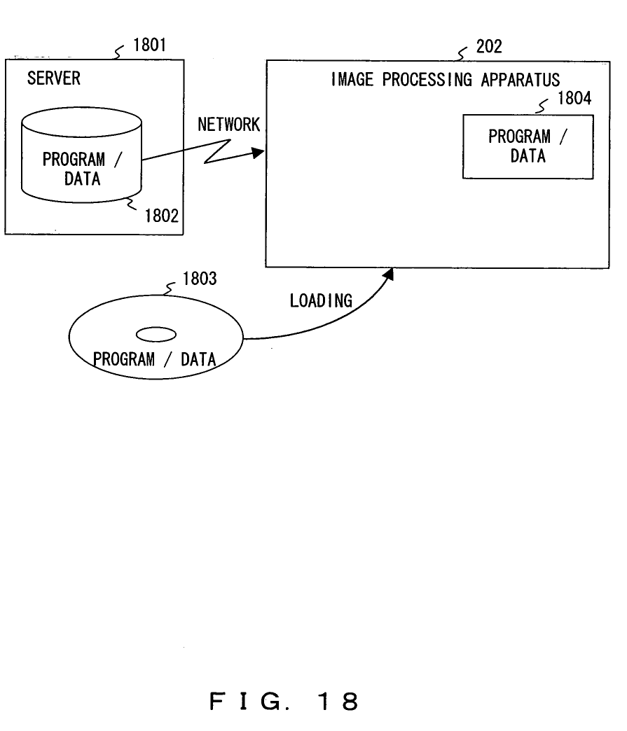

FIG. 18 has the method of loading a program and data required in the image processing apparatus 202 shown in FIG. 2. The program and data are stored in a database 1802 of a server 1801 or a portable recording medium 1803, and are loaded to memory (ROM) 1804 provided in the image extraction unit 212, the detection unit 213, the recognition unit 214, etc. The portable recording medium 1803 can be a computer-readable recording medium such as a memory card, a flexible disk, an optical disk, a magneto-optical disk, etc.

Furthermore, the server 1801 generates a propagation signal for propagating the program and the data, and transmits it to the image processing apparatus 202 through a transmission medium over a network. The CPU provided in the image extraction unit 212, the detection unit 213, the recognition unit 214, etc. executes the loaded program using the loaded data, and performs a necessary process.

In the above-mentioned embodiment, the process of detecting and recognizing a vehicle on a common road has been described, but the present invention can be used in detecting a mobile object on an image captured by a camera, and performing a recognizing process for detailed description of the detected mobile object. For example, the present invention can be applied to the product management on a production line of a factory, and the monitor of intruders as a part of the security system.

When the present invention is applied to the product management, various parts traveling on the production line in the production process are to be monitored by a camera. In this case, the following methods are used.

(1) Sorting the Parts According to Identification Information such as a Production Number, etc.

When a part is detected, the identification information described on its tag, etc. is recognized, and the detected part is sorted into an appropriate process.

(2) Sorting Defectives

When a part is detected, its shape is recognized. Unless the recognized shape matches a predetermined shape, the detected part is determined as a defective.

The shapes of the detection window and the recognition window in each of the above-mentioned embodiments are not limited to a rectangle, but any other polygons, shapes enclosed by curves can be used.

The present invention can be used in detecting and recognizing a mobile object on an image such as identification of a vehicle on a common road, product management on a production line of a factory, monitor of intruders as a part of a security system, etc.

1. An image processing apparatus which identifies a mobile object contained in an image captured by a high-resolution camera, comprising:
an extraction device extracting as a partial image a part of a high-resolution image captured by the high-resolution camera, and generating a low-resolution image having lower resolution;
a detection device detecting the mobile object using the low-resolution image; and
a recognition device recognizing the mobile object using a high-resolution image transmitted from the high-resolution camera when the mobile object is detected, and outputting a recognition result.

2. The apparatus according to claim 1, wherein
said extraction device extracts a plurality of partial images using a plurality of windows provided and arranged at an upper end, a lower end, a left end, or a right end of the high-resolution image captured by the high-resolution camera, and generates a low-resolution image by arranging the plurality of partial images in one direction.

3. The apparatus according to claim 1, wherein
said extraction device extracts a plurality of partial images from the high-resolution image captured by the high-resolution camera, generates a low-resolution image by combining the plurality of partial images, and generates a video picture from low-resolution images consecutive in a time series, and said detection device detects the mobile object using the generated video picture.

4. The apparatus according to claim 1, wherein
said extraction device extracts two partial images from the high-resolution image captured by the high-resolution camera, and generates a video picture by alternately inserting the two partial images as respective low-resolution images, and said detection device detects the mobile object using the generated video picture.

5. The apparatus according to claim 1, wherein
said extraction device extracts the partial image using a window provided at a closest position to a running direction of the mobile object which enters the high-resolution image captured by the high-resolution camera.

6. The apparatus according to claim 1, wherein
said extraction device extracts the partial image using a window provided in the high-resolution image captured by the high-resolution camera, and changes a size of the window depending on a form of the low-resolution image.

7. The apparatus according to claim 1, wherein
said extraction device extracts the partial image using a window provided in the high-resolution image captured by the high-resolution camera, and changes an angle of the window depending on a traveling direction of the mobile object.

8. The apparatus according to claim 1, wherein
said extraction device comprises a storage device storing information about a plurality of windows in the high-resolution image captured by the high-resolution camera, extracts a portion showing movement from the high-resolution image captured by the high-resolution camera, selects an optimum window from the plurality of windows, and extracts the partial image using the selected window.

9. The apparatus according to claim 1, further comprising a storage device storing information about a plurality of detection windows in the high-resolution image captured by the high-resolution camera, and information about a recognition window associated with each detection window, wherein said extraction device extracts a plurality of partial images using the plurality of detection windows, and generates a low-resolution image by combining the plurality of partial images, and when the mobile object is detected from a partial image in the low-resolution image, said recognition device extracts a recognition image from the high-resolution image transmitted from the high-resolution camera using a recognition window corresponding to a detection window used in extracting a partial image in which the mobile object is detected.

10. An image processing apparatus which identifies a vehicle contained in an image captured by a high-resolution camera, comprising:
an extraction device extracting as a partial image a part of a high-resolution image captured by the high-resolution camera, and generating a low-resolution image having lower resolution;
a detection device detecting the vehicle using the low-resolution image; and
a recognition device recognizing the vehicle using a high-resolution image transmitted from the high-resolution camera when the vehicle is detected, and outputting a recognition result.

11. A recording medium recording a program for an image processing apparatus which identifies a mobile object contained in an image captured by a high-resolution camera, the program directing the apparatus to perform:
extracting as a partial image a part of a high-resolution image captured by the high-resolution camera,
generating a low-resolution image having lower resolution;
detecting the mobile object using the low-resolution image;
recognizing the mobile object using the high-resolution image transmitted from a high-resolution camera when the mobile object is detected, and
outputting a recognition result.

12. A propagation signal for propagating a program for an image processing apparatus which identifies a mobile object contained in an image captured by a high-resolution camera, the program directing the apparatus to perform:
extracting as a partial image a part of a high-resolution image captured by the high-resolution camera, generating a low-resolution image having lower resolution;
detecting the mobile object using the low-resolution image;
recognizing the mobile object using a high-resolution image transmitted from the high-resolution camera when the mobile object is detected, and
outputting a recognition result.

13. An image processing method of identifying a mobile object contained in an image captured by a high-resolution camera, comprising:
extracting as a partial image a part of a high-resolution image captured by the high-resolution camera,
generating a low-resolution image having lower resolution;
detecting the mobile object using the low-resolution image; and
recognizing the mobile object using a high-resolution image transmitted from the high-resolution camera when the mobile object is detected.

14. An image processing apparatus which identifies a mobile object contained in an image captured by a high-resolution camera, comprising:
extraction means for extracting as a partial image a part of a high-resolution image captured by the high-resolution camera, and generating a low-resolution image having lower resolution;
detection means for detecting the mobile object using the low-resolution image; and
recognition means for recognizing the mobile object using a high-resolution image transmitted from the high-resolution camera when the mobile object is detected, and outputting a recognition result.
